(19) United States
(12) Patent Application Publication
(10) Pub. No.: US 2026/0369240 A1
(43) Pub. Date: Nov. 19, 2026

(54) LIGHT EMITTING DEVICE, DRIVER AND DRIVING METHOD THEREOF

(71) Applicant: HIMAX TECHNOLOGIES LIMITED, Tainan City (TW)

(72) Inventors: Hsuan-Ching Liu, Tainan City (TW); Chien-Chieh Peng, Tainan City (TW); Wei-Jen Chang, Tainan City (TW)

(73) Assignee: HIMAX TECHNOLOGIES LIMITED, Tainan City (TW)

(21) Appl. No.: 19/209,827

(22) Filed: May 16, 2025

(51) Int. Cl. G09G 3/34; G09G 3/32

(52) U.S. Cl. CPC G09G 3/3426; G09G 3/32; G09G 2310/06; G09G 2310/08; G09G 2320/0233; G09G 2320/0247; G09G 2320/064; G09G 2320/0653; G09G 2320/0686; G09G 2330/06

(57) ABSTRACT

A driver includes a compensation circuit and a driving signal generator. The compensation circuit receives a synchronous signal, resets a counting operation according to the synchronous signal. When a count value of the counting operation is larger than a threshold value, the compensation circuit sets a pulse width value of next display frame equal to a pulse width value of current display frame. The driving signal generator is coupled to the compensation circuit, and generates a driving signal to a light emitting component according to a pulse width value of each of display frames.

### BACKGROUND

### Technical Field

The disclosure relates to a light emitting device, a driver and a driving method thereof and the light emitting device, the driver and the driving method for compensating flicker effect.

### Description of Related Art

In conventional art, a local dimming scheme is provided in a light emitting device such as a back-light device. The local dimming scheme is applicated to enhance a contrast of a display device and save a power consumption. The light emitting device is configured to generate a synchronous signal by a timing control circuit and reset a counting operation according to the synchronous signal. By the counting operation, the light emitting device can control a width of enable pulses of driving signals. In actual application, if the synchronous signal is loss by some abnormal reasons, such as ESD or EMS event, the counting operation cannot be reset and driving signals cannot generated normally, and flicker phenomenon can of the display device be induced.

### SUMMARY

The disclosure provides a light emitting device, a driver and a driving method thereof. The driver may detect whether a synchronous signal is loss or not, and keep the light emitting device operating normally when the synchronous signal is loss.

The driver includes a compensation circuit and a driving signal generator. The compensation circuit receives a synchronous signal, resets a counting operation according to the synchronous signal. When a count value of the counting operation is larger than a threshold value, the compensation circuit sets a pulse width value of next display frame equal to a pulse width value of current display frame. The driving signal generator is coupled to the compensation circuit, and generates a driving signal to a light emitting component according to a pulse width value of each of display frames.

The light emitting device includes a light emitting component and the driver as mentioned above. The driver is coupled to the light emitting component.

The driving method is adapted for a light emitting device, and includes: receiving a synchronous signal by a compensation circuit; resetting a counting operation according to the synchronous signal by the compensation circuit; setting a pulse width value of next display frame equal to a pulse width value of current display frame when a count value of the counting operation is larger than a threshold value by the compensation circuit; and, generating a driving signal to a light emitting component according to a pulse width value of each of display frames by a driving signal generator.

Based on the above, the driver of present disclosure provides a compensation circuit to detect whether the synchronous signal of the light emitting device is loss or not. When the synchronous signal is loss, the driver sets the pulse width value of next display frame equal to the pulse width value of current display frame, and generates the driving signal for the next display frame according to the pulse width value of current display frame. Such as that, a chance of flickering caused by the loss synchronous signal on the light emitting device can be reduced, and performance of the light emitting device can be enhanced accordingly.

### BRIEF DESCRIPTION OF THE DRAWINGS

FIG. 1 illustrates a schematic diagram of a light emitting device according to an embodiment of present disclosure.

FIG. 2A illustrates a schematic diagram of a compensation circuit of the driver according to the embodiment of FIG. 1.

FIG. 2B illustrates a schematic diagram for generating the reference value according to the embodiment of FIG. 2A.

FIG. 3A to FIG. 3C illustrate waveform plots of a driver according to an embodiment of present disclosure.

FIG. 4 illustrates a flow chart of a compensation method for a light emitting device according to an embodiment of present disclosure.

FIG. 5A and FIG. 5B illustrate schematic diagrams of light emitting components according to an embodiment of present disclosure.

FIG. 6 illustrates a flow chart of a driving method for a light emitting device according to an embodiment of present disclosure.

### DETAILED DESCRIPTION OF DISCLOSED EMBODIMENTS

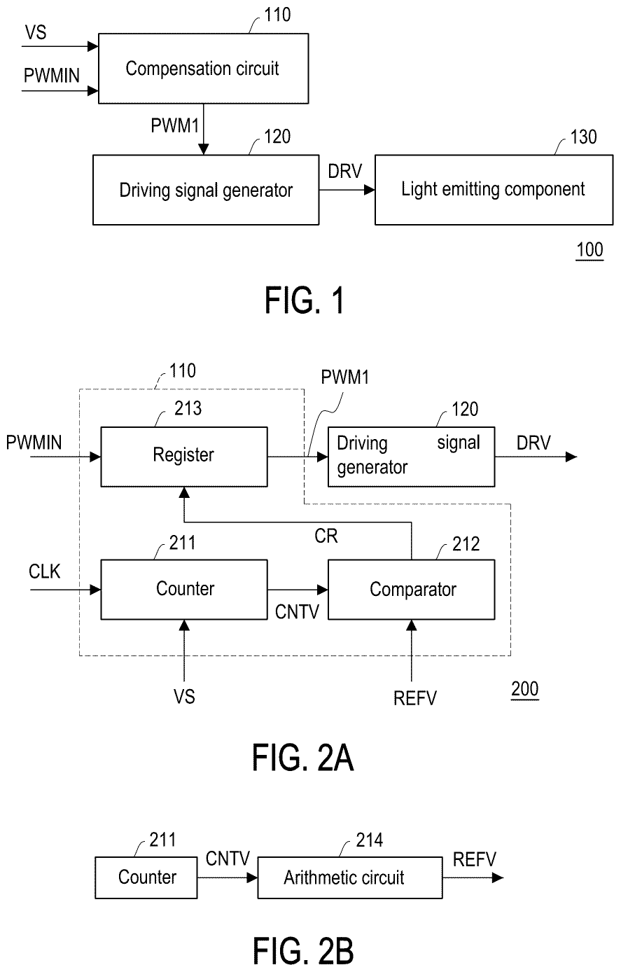

Please refer to FIG. 1, which illustrates a schematic diagram of a light emitting device according to an embodiment of present disclosure. The light emitting device includes a driver and a light emitting component 130. The driver 100 includes a compensation circuit 110 and a driving signal generator 120, and is configured to drive the light emitting component 130. The compensation circuit 110 receives a synchronous signal VS and input pulse width value PWMIN. The driving signal generator 120 is coupled to the compensation circuit 110. The driving signal generator 120 is configured to receive a pulse width value PWM1 from the compensation circuit 110, and generate a driving signal DRV according to the pulse width value PWM1. Furthermore, the driving signal generator 120 provides the driving signal DRV to the light emitting component 130 of the light emitting device 100.

In this embodiment, the synchronous signal VS and input pulse width value PWMIN may be provided by a timing control (T-CON) circuit of the light emitting device 100.

In this embodiment, the compensation circuit 110 is configured to detect whether the synchronous signal VS is loss or not. In detail, the compensation circuit 110 may perform a counting operation, and the counting operation can be reset by the received synchronous signal VS. In some embodiment, the compensation circuit 110 may perform the counting operation by a counter, where the counter may be a up counter. When the synchronous signal VS provides an enable pulse, the counter may be reset and a count value generated by the counter may be 0. After the enable pulse of the synchronous signal VS, the counter may start the counting operation to increase the count value by 1 based on a period of a clock signal received by the counter.

The compensation circuit 110 may also compare the count value with a reference value. In this embodiment, the timing controller may provide the synchronous signal VS with one enable pulse per display frame. In a normal operation, if the synchronous signal VS is normally received and not loss during the operation, before the count value generated by the counter reaches to the reference value, the count value generated by the counter should be reset to 0 according to one enable pulse of the synchronous signal VS. The reference value may be set by dividing a normal time length of one display frame with the period of the clock signal. In detail, a quotient of the normal time length of one display frame dividing the period of the clock signal may be a threshold value, and the reference value may be a sum of the threshold value and an offset value, where the offset value is a positive value.

On the other hand, in an abnormal operation, if the enable pulse of the synchronous signal VS is loss and not received by the counter, the counter is not reset and the count value generated by the counter may be larger than the threshold value. In this embodiment, if the count value generated by the counter reaches to the reference value, the compensation circuit 110 may determine the synchronous signal VS is loss.

When the synchronous signal VS being loss has been determined, the compensation circuit 110 may set a pulse width value of next display frame equal to the pulse width value PWM1 of current display frame.

The driving signal generator 120 is configured to receive the pulse width value PWM1, and generates the driving signal DRV according to the pulse width value PWM1. In detail, in each of the display frames, the driving signal generator 120 may generate the driving signal DRV with an enable pulse, and a width of the enable pulse may be determined according to the pulse width value PWM1. In this embodiment, if at an end time point of current display frame, the compensation circuit 110 determines the synchronous signal VS is loss, the compensation circuit 110 may keep the pulse width value for the next display frame equal to the pulse width value PWM1 for the current display frame unchanged. Such as that, the width of the enable pulse of the driving signal DRV of the next display frame may be same as the width of the enable pulse of the driving signal DRV of the current display frame. Such as that, a luminance of the light emitting component 130 may not be increased or decreased suddenly, and chance of flickering caused by the loss synchronous signal VS on the light emitting device 100 can be reduced, and performance of the light emitting device 100 can be enhanced accordingly.

It should be noted here, the light emitting component 130 may be formed by at least one light emitting diode (LED), and configured to a back-light device of a display device. In some embodiment, one or more light emitting components 130 can be disposed in the back-light device, and a luminance of each of the light emitting components 130 can be adjusted individually to achieve a local dimming function.

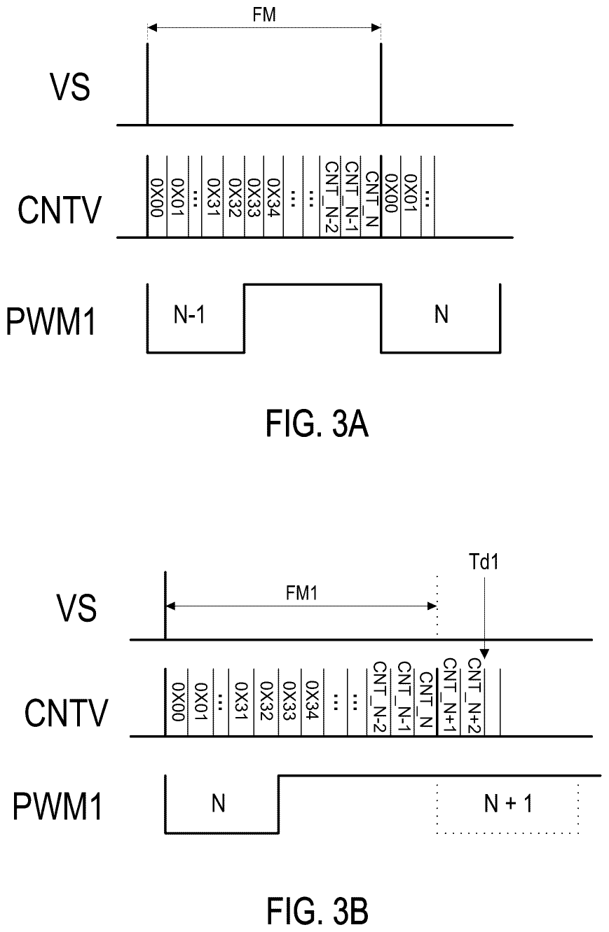

Please refer to FIG. 2A, which illustrates a schematic diagram of a compensation circuit of the driver according to the embodiment of FIG. 1. The driver 200 may include a counter 211, a comparator 212 and a register 213. The counter 211 receives a clock signal CLK and the synchronous signal VS, and performs a counting operation based on the clock signal CLK to generate a count value CNTV. The counting operation performed by the counter 211 may be reset by the synchronous signal VS. If the synchronous signal VS is not loss, a enable pulse on the synchronous signal VS may reset the counter 211, and the counter 211 may reset the count value CNTV to 0. On the contrary, if the synchronous signal VS is loss, the count value CNTV may be increased to reach to a reference value REFV. The comparator 212 is coupled to the counter 211 to receive the count value CNTV, and the comparator 212 further receives the reference value REFV. The comparator 212 compares the count value CNTV with the reference value REFV to generate a detection result CR. If the count value CNTV is smaller than the reference value REFV, the comparator 212 may generate the detection result CR with a first logic value to indicate the synchronous signal VS is not loss. On the contrary, if the count value CNTV is equal to or larger than the reference value REFV, the comparator 212 may generate the detection result CR with a second logic value to indicate the synchronous signal VS is loss. The first logic value and the second logic value are different.

It should be noted here, when the comparator 212 determines the count value CNTV is equal to or larger than the reference value REFV, the comparator 212 can also transfer information about the loss synchronous signal VS to the counter 211 to reset the counting operation at a same time.

The register 213 is coupled to the comparator 212. The register 213 is configured to store a plurality of input pulse width values PWMIN respectively corresponding to a plurality of display frames. In this embodiment, a timing control circuit may, corresponding to each of the display frames, transport the input pulse width value PWMIN to the register 213. In some embodiment, the register 213 may be a first-in-first-out (FIFO) buffer. The register 213 may store the plurality of input pulse width values PWMIN corresponding to the plurality of display frames in sequential. Furthermore, the register 213 is also coupled to the driving signal generator 120. During each of the display frames, the register 213, during a normal operation, may provide corresponding pulse width value PWM1 from one of the stored input pulse width values PWMIN to the driving signal generator 120. Such as that, the driving signal generator 120 may control a pulse width of an enable pulse of the driving signal DRV according to the pulse width value PWM1 corresponding to each of the display frames.

During an abnormal operation, if the detection signal CR indicates the synchronous signal VS is loss, an input pulse width value of next display frame received by the register 213 may be not correct. Therefore, the register 213 may, according to the detection signal CR, output the pulse width value of current display frame to be the pulse width value of next display frame to the driving signal generator 120.

About circuit structures of the counter 211 and the comparator 212, the counter 211 may be any counter circuit well known by a person skilled in the art. The comparator 212 also can be implemented by any comparing circuit well known by a person skilled in the art, and no special limitation here.

Please refer to FIG. 2B, which illustrates a schematic diagram for generating the reference value according to the embodiment of FIG. 2A. In FIG. 2B, the counter 211 is further coupled to an arithmetic circuit 214. The arithmetic circuit 214 is configured to generate the reference value REFV to the comparator 212. The arithmetic circuit 214 may receives a plurality of numbers of the count value CNTV respectively corresponding to a plurality of display frames from the counter 211, and calculates the threshold value by averaging the plurality of numbers of the count value CNTV. Furthermore, the arithmetic circuit 214 may generate the reference value REFV by adding the threshold value with an offset value.

In this embodiment, during the normal operations, the count value CNTV of each display frame may represent a time length between two adjacent enable pulses of the synchronous signal VS. That is, the arithmetic circuit 214 may calculates the threshold value by averaging the plurality of numbers of the count value CNTV. Further, by adding the threshold value with the offset value to generate the reference value REFV, the comparator 212 can determine whether the synchronous signal VS is loss or not by comparing the count value CNTV of current display frame with the reference value REFV.

In additional, the offset value can be set by a designer, and no more special limitation here.

The arithmetic circuit 214 may be a logic circuit, and may be designed by any digital circuit design strategy well known by a person skilled in the art, and no special limitation here.

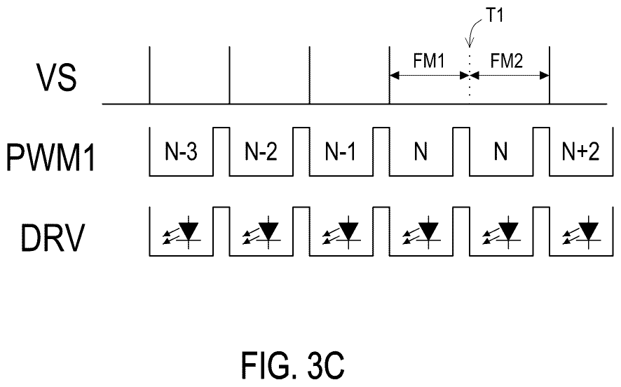

Please refer to FIG. 3A to FIG. 3C and FIG. 2 commonly, wherein FIG. 3A to FIG. 3C illustrate waveform plots of a driver according to an embodiment of present disclosure. In FIG. 3A, in the normal operation, the synchronous signal VS provides a enable pulse at one start time point of one display frame FM. The counter 211 may perform the counting operation during the display frame FM, and the count value CNTV of the counter 211 can be increased from 0x00 (hexadecimal 0). Take the threshold value equals to Cnt_N as an example, when the count value CNTV reaches to the threshold value (=Cnt_N), the display frame FM is finished and a next one display frame (i.e. the display frame FM1 in FIG. 3B) can be started. Also in the normal operation, the synchronous signal VS further provides another enable pulse at a start time point of the next display frame (the display frame FM1 in FIG. 3B). The count value CNTV of the counter 211 can be reset to 0x00. The counter 211 may perform the counting operation again during the next display frame (the display frame FM1 in FIG. 3B) to increase the count value CNTV.

On the other hand, during the display frame FM, the register 213 may provide the pulse width value PWM1 with a value N−1, and during the next display frame (the display frame FM1 in FIG. 3B) after the display frame FM, the register 213 may provide the pulse width value PWM1 with a value N.

Description continued from FIG. 3A, in FIG. 3B, during the display frame FM1, the counter 211 performs the counting operation to generate the count value CNTV from 0x00 to Cnt_N. At an end time point of the display frame FM1, the synchronous signal VS fails to provide the enable pulse, the counter 211 does not reset the count value CNTV to 0x00 and the count value CNTV keeps on increasing. When the count value CNTV reaches to the reference value (equals to Cnt_N+2 for example), the synchronous signal VS is loss can be determined at a time point Td1.

In this embodiment, the offset value may be set to 2, and the reference value REFV may be equaled to the threshold value (Cnt_N) +the offset value (2). Of course, in other embodiments, the offset value may be set to another value rather than 2, and the offset value my be determined by a designer and no special limitation here.

In FIG. 3B, when the synchronous signal VS being loss is determined, the pulse width value PWM1 equals to N+1 provided by the register 213 may be not correct. Such as that, in the FIG. 3C, during the display frame FM2, the register 213 may provide the pulse width value PWM1 with a value N which is same as the pulse width value PWM1 in the display frame FM1.

In FIG. 3C, the register 213 may provide the pulse width value PWM1 with values N−3, N−2, N−1, N, N, N+2 in sequential respectively corresponding to multiple consecutive display frames. The driving signal DRV can provide a plurality of enable pulses respectively corresponding to the display frames, and widths of the enable pulses can be determined according to the values of the pulse width value PWM1, respectively. In this embodiment, when the driving signal DRV is at a low voltage, the corresponding light emitting component can be lighted up, and the width of each of the enable pulse of the driving signal DRV is related to a luminance of the light emitting component in each of the display frames.

In this embodiment, a time point T1 for switching the display frame FM1 to the display frame FM2 can be determined according to the time point Td1 in FIG. 3B. In some embodiment, the time point T1 may be same as the time point Td1.

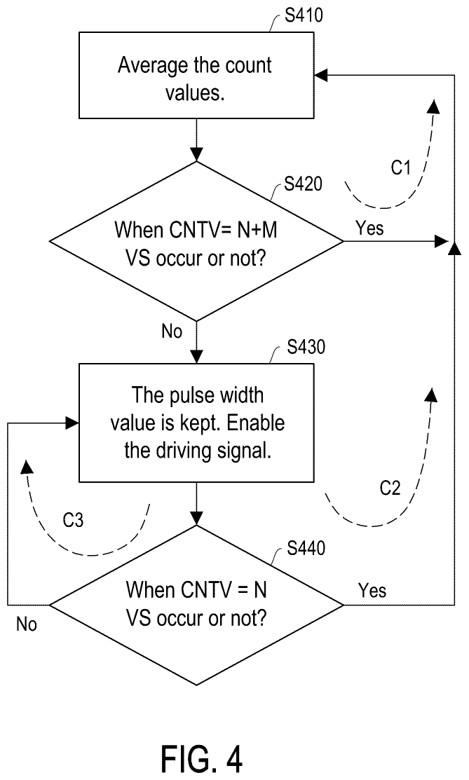

Please refer to FIG. 2A, FIG. 2B and FIG. 4 commonly, wherein FIG. 4 illustrates a flow chart of a compensation method for a light emitting device according to an embodiment of present disclosure. In step S410, the arithmetic circuit 214 may average a plurality numbers of the count values CNTV generates by the counter 211 to determine the threshold value. The number of the count values CNTV for averaging by the arithmetic circuit 214 can be decided by the designer of the driver 200, and no special limitation here. In step S420, when the count value CNTV =the threshold value (N)+the offset value (M), the synchronous signal VS is occurred or not may be judged, and if a judge result of the step S420 is yes, a case C1 may be happened and the step S410 can be executed again, wherein the case C1 is direct to an event that the synchronous signal VS is not missed. If the judge result of the step S420 is no, step S430 can be executed. In the step S430, the register 213 may keep the provided pulse width value unchanged, and the driving signal generator 120 may enable the driving signal DRV according to the provided pulse width value.

In step 440, when the count value CNTV=the threshold value (N)+the offset value (M), the synchronous signal VS is occurred or not may be judged again, and if a judge result of the step S440 is yes, a case C2 may be happened and the step S410 can be executed again, wherein the case C2 is direct to an event that the synchronous signal VS is missed once. If the judge result of the step S440 is no, a case C3 may be happened and the step S430 can be executed again, wherein the case C3 is direct to an event that the synchronous signal VS is missed larger than 1 time.

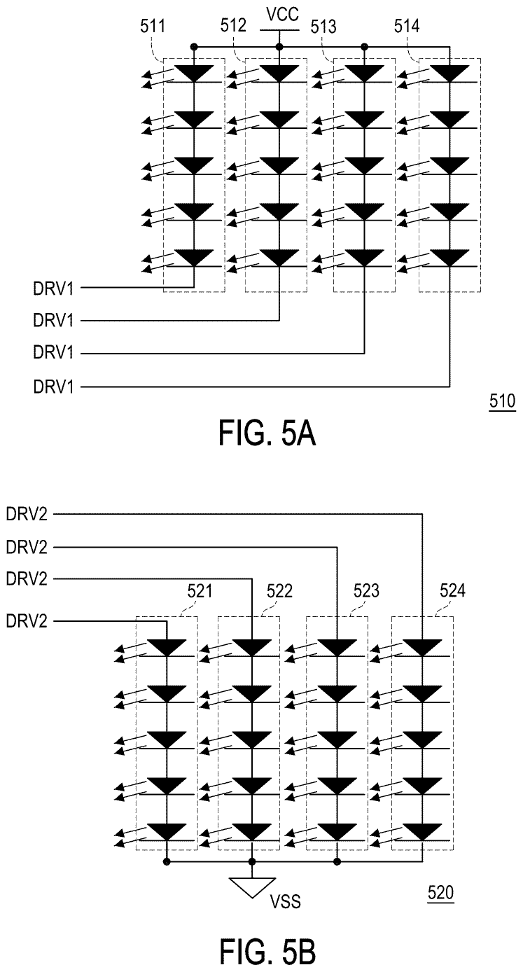

Please refer to FIG. 5A and FIG. 5B, which illustrate schematic diagrams of light emitting components according to an embodiment of present disclosure. In FIG. 5A, the light emitting component 510 includes a plurality of light emitting diode (LED) strings 511 to 514. Each of the LED strings 511 to 514 includes a plurality of LEDs coupled in series. In this embodiment, the LED strings 511 to 514 are coupled in a common anode manner. That is, anodes of the LEDs in the LED strings 511 to 514 are commonly coupled to a power voltage VCC. Cathodes of the LEDs in the LED strings 511 to 514 receives a plurality of driving signals DRV1.

In this embodiment, when each of the driving signals DRV1 is pulled low and provides a negative pulse, each of the corresponding LED strings 511 to 514 can be lighted up. In this embodiment, the drive signal generator may generate the driving signals DRV1 with same waveform, or the drive signal generator may generate the driving signals DRV1 with different waveforms.

In FIG. 5B, the light emitting component 520 includes a plurality of LED strings 521 to 524. Each of the LED strings 521 to 524 includes a plurality of LEDs coupled in series. In this embodiment, the LED strings 521 to 524 are coupled in a common cathode manner. That is, cathodes of the LEDs in the LED strings 521 to 524 are commonly coupled to a reference ground voltage VSS. Anodes of the LEDs in the LED strings 521 to 524 receives a plurality of driving signals DRV2.

In this embodiment, when each of the driving signals DRV2 is pulled high and provides a positive pulse, each of the corresponding LED strings 521 to 524 can be lighted up. In this embodiment, the drive signal generator may generate the driving signals DRV2 with same waveform, or the drive signal generator may generate the driving signals DRV2 with different waveforms.

In the embodiments of FIG. 5A and FIG. 5B, number of the LEDs of each of the LED string 511 to 524 equal to 5 is just an example for illustrative purposes. A person skilled in the art can adjust the number of the LEDs of each of the LED string 511 to 524 by actual necessary. In some embodiments, the number of LEDs of one LED string may be same as or different from the number of LEDs of another LED string. Moreover, a number of the LED strings in one light emitting component equal to 4 is also just an example for illustrative purposes, and the person skilled in the art can adjust the number of the LED strings of one light emitting component by actual necessary, too.

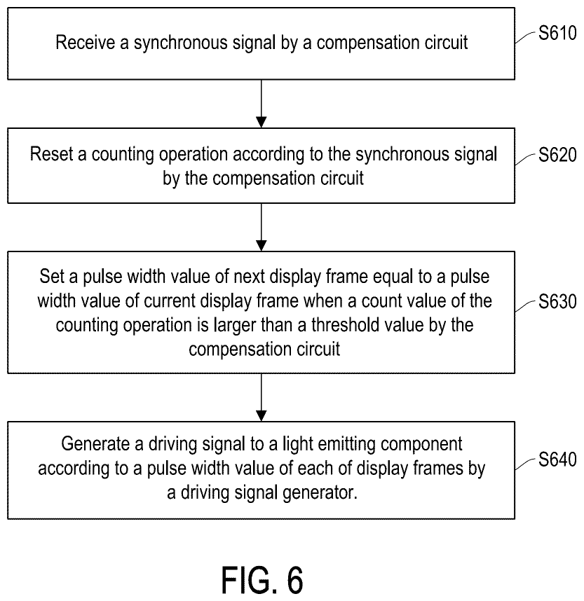

Please refer to FIG. 6, which illustrates a flow chart of a driving method for a light emitting device according to an embodiment of present disclosure. In step S610, a synchronous signal is received by a compensation circuit. In step S620, a count operation may be reset by the compensation circuit according to the synchronous signal. In step S630, a pulse width value of next display frame may be set to equal to a pulse width value of current display frame when a count value of the counting operation is larger than a threshold value by the compensation circuit. In step S640, a driving signal may be generated to a light emitting component according to a pulse width value of each of display frames by a driving signal generator.

Details operation of the steps S610 to S640 have been detailly described in embodiments mentioned above, and no more repeated descriptions here.

In summary, the driver of the light emitting device of present disclosure detects whether the synchronous signal is loss or not. When the synchronous signal is loss, the driver keeps the pulse width value of the driving signal of next display frame same as the pulse width value of the driving signal of current display frame. Such as that, a chance of flickering caused by the loss synchronous signal on the light emitting device can be reduced, and performance of the light emitting device can be enhanced accordingly.

1. A driver for a light emitting device, comprising:
a compensation circuit, configured to receive a synchronous signal, reset a counting operation according to the synchronous signal, and when a count value of the counting operation is larger than a threshold value, the compensation circuit is configured to set a pulse width value of next display frame equal to a pulse width value of current display frame; and
a driving signal generator, coupled to the compensation circuit, and configured to generate a driving signal to a light emitting component according to a pulse width value of each of display frames,
wherein the compensation circuit is further configured to compare the count value with a reference value, and when the count value reaches to the reference value, the compensation circuit is configured to generate a detection signal, wherein detection signal is configured to indicate the synchronous signal fails to provide an enable pulse, and the reference value is larger than the threshold value.

2. (canceled)

3. The driver according to claim 1, wherein the reference value equals to a sum of the threshold value and an offset value, wherein the offset value is a positive value.

4. The driver according to claim 1, wherein the compensation circuit comprises:
a counter, configured to receive the synchronous signal and a clock signal, and perform the counting operation based on the clock signal to generate the count value, wherein the counter resets the count value when the synchronous signal provides an enable pulse;
a comparator, coupled to the counter, configured to receive the counting value and a reference value, and compare the counting value with the reference value to generate the detection signal; and
a register, coupled to the comparator, configured to sequentially provide plurality of pulse width values respectively corresponding to a plurality of display frames.

5. The driver according to claim 4, wherein the register is further configured to provide the pulse width value of next display frame equal to the pulse width value of current display frame when the detection signal indicating the synchronous signal fails to provide an enable pulse.

6. The driver according to claim 4, wherein the driving signal generator, during each of the display frames, is configured to generate the driving signal by comparing the count value with the corresponding pulse width value.

7. The driver according to claim 6, wherein the pulse is a positive pulse or a negative pulse.

8. The driver according to claim 4, wherein the compensation circuit further comprises:
a logic circuit, coupled between the counter and the comparator, configured to average a plurality of the count values respectively corresponding to the display frames to obtain the threshold value, and generate the reference value by adding the threshold value with an offset value.

9. A light emitting device, comprising:
a light emitting component; and
a driver, coupled to the light emitting component, comprising:
a compensation circuit, configured to receive a synchronous signal, reset a counting operation according to the synchronous signal, and when a count value of the counting operation is larger than a threshold value, the compensation circuit is configured to set a pulse width value of next display frame equal to a pulse width value of current display frame; and
a driving signal generator, coupled to the compensation circuit, configured to generate a driving signal to a light emitting device according to a pulse width value of each of display frames,
wherein the compensation circuit is further configured to compare the count value with a reference value, and when the count value reaches to the reference value, the compensation circuit is configured to generate a detection signal, wherein detection signal is configured to indicate the synchronous signal fails to provide an enable pulse, and the reference value is larger than the threshold value.

10. (canceled)

11. The light emitting device according to claim 9, wherein the reference value equals to a sum of the threshold value and an offset value, wherein the offset value is a positive value.

12. The light emitting device according to claim 9, wherein the compensation circuit comprises:
a counter, configured to receive the synchronous signal and a clock signal, and perform the counting operation based on the clock signal to generate the count value, wherein the counter resets the count value when the synchronous signal provides an enable pulse;
a comparator, coupled to the counter, configured to receive the counting value and a reference value, and compare the counting value with the reference value to generate the detection signal; and
a register, coupled to the comparator, configured to sequentially provide a plurality of pulse width values respectively corresponding to a plurality of display frames.

13. The light emitting device according to claim 12, wherein the register is further configured to provide the pulse width value of next display frame equal to the pulse width value of current display frame when the detection signal indicating the synchronous signal fails to provide an enable pulse.

14. The light emitting device according to claim 12, wherein the compensation circuit further comprises:
a logic circuit, coupled between the counter and the comparator, configured to average a plurality of the count values respectively corresponding to the display frames to obtain the threshold value, and generate the reference value by adding the threshold value with an offset value.

15. The light emitting device according to claim 9, wherein the light emitting component comprises:
at least one light emitting diode string, wherein a first end of the light emitting diode string receives an operation voltage or a reference ground voltage, and a second end of the light emitting diode string receives the driving signal.

16. A driving method, adapted for a light emitting device, comprising:
receiving a synchronous signal by a compensation circuit;
resetting a counting operation according to the synchronous signal by the compensation circuit;
setting a pulse width value of next display frame equal to a pulse width value of current display frame when a count value of the counting operation is larger than a threshold value by the compensation circuit,
wherein step of setting the pulse width value of next display frame comprises:
comparing the count value with a reference value, when the count value reaches to the reference value, and
generating a detection signal, wherein detection signal is configured to indicate the synchronous signal fails to provide an enable pulse, and the reference value is larger than the threshold value; and
generating a driving signal to a light emitting component according to a pulse width value of each of display frames by a driving signal generator.

17. (canceled)

18. The driving method according to claim 16, wherein the reference value equals to a sum of the threshold value and an offset value, wherein the offset value is a positive value.

19. The driving method according to claim 16, further comprising:
providing, by a register of the compensation circuit, the pulse width value of next display frame equal to the pulse width value of current display frame when the detection signal indicating the synchronous signal fails to provide an enable pulse.

20. The driving method according to claim 16, further comprising:
averaging a plurality of the count values respectively corresponding to the display frames to obtain the threshold value; and
generating the reference value by adding the threshold value with an offset value.
